(19) United States
(12) Patent Application Publication
(10) Pub. No.: US 2026/0211724 A1
(43) Pub. Date: Jul. 23, 2026

(54) TASK SCHEDULING METHOD AND APPARATUS BASED ON MULTI-CORE PROCESSOR, ELECTRONIC DEVICE, STORAGE MEDIUM, SYSTEM AND COMPUTER PROGRAM PRODUCT

(71) Applicant: Samsung Electronics Co., Ltd., Suwon-si (KR)

(72) Inventors: Weian Mao, Xi'an (CN); Xinyi Zhao, Xi'an (CN); Yibin Zhang, Xi'an (CN)

(21) Appl. No.: 19/074,701

(22) Filed: Mar. 10, 2025

(30) Foreign Application Priority Data
Jan. 20, 2025 (CN) 202510088099.3

(51) Int. Cl. G06F 9/48; G06F 9/50

(52) U.S. Cl. CPC G06F 9/4887; G06F 9/5083

(57) ABSTRACT

A task scheduling method of a multi-core processor includes acquiring a first scheduling parameter, a second scheduling parameter, and a first running parameter in response to a task ready event, obtaining, based on the first scheduling parameter and the first running parameter, a ready-task affinity of each processor core with the ready task, obtaining, based on the second scheduling parameter and the first running parameter, a current-task affinity of each processor core with the current task, selecting, from the multi-core processor, at least one processor core as at least one alternative processor core, wherein the at least one processor core has a ready-task affinity higher than a current-task affinity, selecting, from the at least one alternative processor core, a processor core with the highest ready-task affinity as a target processor core, and scheduling the ready task to run on the target processor core.

### CROSS-REFERENCE TO RELATED APPLICATION(S)

This application claims priority under 35 U.S.C. § 119 to Chinese Patent Application No. 202510088099.3 filed on Jan. 20, 2025 in the China National Intellectual Property Administration (CNIPA), the disclosure of which is incorporated by reference herein in its entirety.

### TECHNICAL FIELD

The present disclosure relates to the field of computing system, and particularly relates to a task scheduling method and apparatus based on a multi-core processor, an electronic device, a storage medium, a system, and a computer program product.

### BACKGROUND ART

With the development of science and technology, processors demand higher and higher performance requirements. A single-core processor can no longer meet the requirement of high performance, and a symmetric multiprocessing system using a multi-core processor (a multi-processor computer hardware architecture, that is, a multi-core processor) has become the mainstream choice for high-performance systems. The issue of processor power consumption has gained increasing attention from both users and suppliers. In the embedded domain, low-power characteristics of processors have even become a key factor in product competitiveness.

In the related task scheduling schemes of a symmetric multiprocessing system, the power consumption is reduced through the allocation of processor resources and the use of low-power schemes supported by hardware such as Dynamic Voltage and Frequency Scaling (DVFS).

### SUMMARY

A task scheduling method and apparatus based on a multi-core processor, an electronic device, a storage medium, a system and a computer program product provided in exemplary embodiments of the present disclosure may at least solve the above technical problem and other technical problems not mentioned above.

According to an aspect of the present disclosure, a task scheduling method based on a multi-core processor including a plurality of processor cores includes acquiring a first scheduling parameter, a second scheduling parameter, and a first running parameter in a case where a task ready event occurs, wherein the first scheduling parameter is a scheduling parameter of a ready task corresponding to the task ready event, the second scheduling parameter is a scheduling parameter of a current task currently running in each processor core of the plurality of processor cores in the multi-core processor, and the first running parameter is a running parameter of each processor core of the plurality of processor cores, the running parameter comprising a continuous idle duration of each processor core of the plurality of processor cores, obtaining, based on the first scheduling parameter and the first running parameter, a ready-task affinity of each processor core of the plurality of processor cores with the ready task, wherein the obtaining of the ready-task affinity of each processor includes running the ready task on each processor core, and wherein the ready-task affinity of each processor core with the ready task represents an optimization degree of power consumption when each processor core runs the ready task, obtaining, based on the second scheduling parameter and the first running parameter, a current-task affinity of each processor core of the plurality of processor cores with the current task, wherein each processor core runs a corresponding current task or is in an idle state, selecting, from the multi-core processor, at least one processor core as at least one alternative processor core, wherein the at least one processor core has a ready-task affinity higher than a current-task affinity, selecting, from the at least one alternative processor core, a processor core with the highest ready-task affinity as a target processor core, and scheduling the ready task to run on the target processor core.

According to an aspect of the present disclosure, a task scheduling apparatus based on a multi-core processor including a plurality of processor cores includes a parameter acquisition unit configured to acquire a first scheduling parameter, a second scheduling parameter, and a first running parameter in a case where a task ready event occurs, wherein the first scheduling parameter is a scheduling parameter of a ready task corresponding to the task ready event in the multi-core processor, the second scheduling parameter is a scheduling parameter of a current task currently running in each processor core of the plurality of processor cores in the multi-core processor, and the first running parameter is a running parameter of each processor core of the plurality of processor cores, the running parameter comprising a continuous idle duration of each processor core of the plurality of processor cores, an affinity calculation unit configured to: obtain, based on the first scheduling parameter and the first running parameter, a ready-task affinity of each processor core of the plurality of processor cores with the ready task, when each processor core of the plurality of processor cores runs the ready task, wherein the ready-task affinity of each processor core with the ready task represents an optimization degree of power consumption when each processor core of the plurality of processor cores runs the ready task, and obtain, based on the second scheduling parameter and the first running parameter, a current-task affinity when each processor core runs a corresponding task or is in an idle state, and a task scheduling unit configured to: select, from the multi-core processor, at least one processor core as at least one alternative processor core, wherein the at least one processor core has a ready-task affinity higher than a current-task affinity, select, from the at least one alternative processor core, a processor core with the highest affinity as a target processor core, and schedule the ready task to run on the target processor core.

According to an aspect of the present disclosure, an electronic device includes at least one multi-core processor including a plurality of processor cores and executing at least one memory storing computer executable instructions. The computer executable instructions cause the at least one multi-core processor to execute a task scheduling method. The at least one multi-core processor includes a parameter acquisition unit configured to acquire a first scheduling parameter, a second scheduling parameter, and a first running parameter in a case where a task ready event occurs, wherein the first scheduling parameter is a scheduling parameter of a ready task corresponding to the task ready event in the multi-core processor, the second scheduling parameter is a scheduling parameter of a current task currently running in each processor core of the plurality of processor cores in the multi-core processor, and the first running parameter is a running parameter of each processor core of the plurality of processor cores, the running parameter comprising a continuous idle duration of each processor core of the plurality of processor cores, an affinity calculation unit configured to: obtain, based on the first scheduling parameter and the first running parameter, a ready-task affinity of each processor core of the plurality of processor cores with the ready task, when each processor core of the plurality of processor cores runs the ready task, wherein the ready-task affinity of each processor core with the ready task represents an optimization degree of power consumption when each processor core of the plurality of processor cores runs the ready task, and obtain, based on the second scheduling parameter and the first running parameter, a current-task affinity when each processor core runs a corresponding task or is in an idle state, and a task scheduling unit configured to: select, from the multi-core processor, at least one processor core as at least one alternative processor core, wherein the at least one processor core has a ready-task affinity higher than a current-task affinity, select, from the at least one alternative processor core, a processor core with the highest affinity as a target processor core, and schedule the ready task to run on the target processor core.

According to an aspect of the present disclosure, there provides a computer readable storage medium storing instructions, wherein the instructions, when executed by at least one processor, cause the at least one processor to execute the any one task scheduling method based on the multi-core processor as described above.

According to an aspect of the present disclosure, there provides a system including at least one computing device and at least one storage device storing instructions, wherein the instructions, when executed by the at least one computing device, cause the at least one computing device to execute the any one task scheduling method based on the multi-core processor as described above.

According to an aspect of the present disclosure, there provides a computer program product including computer programs/instructions, wherein the computer programs/instructions, when executed by a processor, implement the any one task scheduling method based on the multi-core processor as described above.

The technical solutions provided by the embodiments of the present disclosure at least bring the following beneficial technical effects:

According to the task scheduling method and apparatus based on the multi-core processor, the electronic device, the storage medium, the system and the computer program product in the present disclosure, when an idle duration of a single processor core is equal to the accumulated idle duration of multiple processor cores, power saving of the single processor core will be greater than a sum of power saving of the multiple processor cores, therefore, the idle time of multiple cores in a symmetric multiprocessing system may be integrated from the perspective of system task scheduling, in order to enable the idle processor cores to continuously keep an idle state as much as possible, so that the idle time of the processor cores may be integrated to the greatest extent by increasing a running density of the processor cores on the premise of not affecting the system running efficiency.

In addition, unnecessary migration of tasks between different cores may be reduced as much as possible, and the power consumption caused by task switching may be reduced by avoiding frequent task switching on the premise of satisfying task execution efficiency.

In addition, from the perspective of task scheduling, conditions for supporting hardware low-power schemes are provided to optimize the power consumption of a symmetric multiprocessing system. By comprehensively considering scheduling parameters of tasks and hardware characteristics that affect processor power consumption, low-power task scheduling for a symmetric multiprocessing system is proposed for load balancing, and an affinity representation between tasks and processor cores is proposed to determine the best scheduling scheme for power consumption optimization by comparing the affinity between respective processor cores and tasks during task scheduling.

### BRIEF DESCRIPTION OF THE DRAWINGS

The drawings constitute a part of the description, illustrate embodiments consistent with the present disclosure, explain principles of the present disclosure together with the description, and do not unduly limit the present disclosure.

FIG. 1 illustrates a schematic diagram of a structure of a multi-core processor in the related art;

FIG. 2 illustrates a flowchart of a task scheduling method based on a multi-core processor in an exemplary embodiment of the present disclosure;

FIG. 3 illustrates a schematic diagram of a global ready task list in an exemplary embodiment of the present disclosure;

FIG. 4 illustrates a block diagram of modules for executing a task scheduling method based on a multi-core processor in an exemplary embodiment of the present disclosure;

FIG. 5 illustrates a diagram of the relationship between the idle time of a processor core and a change in mode in an exemplary embodiment of the present disclosure;

FIG. 6 illustrates a schematic diagram of running of a multi-core processor corresponding to a task scheduling scheme in the related art;

FIG. 7 illustrates a schematic diagram of running of a multi-core processor corresponding to a task scheduling scheme in an exemplary embodiment of the present disclosure;

FIG. 8 illustrates a block diagram of a task scheduling apparatus based on a multi-core processor in an exemplary embodiment of the present disclosure; and

FIG. 9 illustrates a block diagram of an electronic device in an exemplary embodiment of the present disclosure.

### DETAILED DESCRIPTION OF EXEMPLARY EMBODIMENTS

In order to enable those skilled in the art to better understand the technical solutions of the present disclosure, the technical solutions in embodiments of the present disclosure will be clearly and completely described below in conjunction with the drawings.

It should be noted that the terms “first”, “second” and the like in the description and claims as well as the above drawings of the present disclosure are used to distinguish similar objects, and are not necessarily used to describe a particular order or sequence. It should be understood that data used so may be interchanged under appropriate circumstances so that the embodiments of the present disclosure described here can be implemented in sequences other than those illustrated or described here. The implementations described in the following embodiments do not represent all implementations consistent with the present disclosure. Rather, they are merely examples of apparatus and method consistent with some aspects of the present disclosure that are specifically described in the appended claims.

It should be noted here that “at least one of several items” occurring in the present disclosure means including these three parallel situations, “any one of the several items”, “a combination of any of the several items”, and “an entirety of the several items”. For example, “including at least one of A and B” means including the following three parallel situations: (1) including A; (2) including B; and (3) including A and B. For another example, “executing at least one of step one and step two” means the following three parallel situations: (1) executing step one; (2) executing step two; and (3) executing step one and step two.

The low-power characteristic of processors is an important competitive advantage for products. For example, the Advanced RISC Machine (ARM) processor was designed with low power consumption in mind from the start. As it evolved to ARM11, the Cortex-M based on ARMv7 even includes hardware support for a sleep mode.

In recent years, low-power schemes for processor systems have become more and more mature.

First of all, low-power technologies at a hardware level have been greatly developed, and the DVFS technologies have been widely used. The DVFS may be used to adjust voltage and frequency according to performance and power consumption requirements of a chip, so as to achieve the requirements with the minimum power consumption in various working requirements.

The embedded operating system FreeRTOS supports an optional low-power mode, allowing hardware to switch to a low-power mode when the system enters idle.

At the same time, the research on low-power technology of a symmetric multiprocessing system is conducted mainly from the two perspectives of processor resource allocation and the use of DVFS technology.

For example, the DVFS technology is directly used to reduce system power consumption by using OSCAR API when writing a multitasking program; or by dividing a task into multiple segments according to a control flow, the time that the task needs to run is obtained according to the different control flows of the task, so as to adjust the operating frequency and voltage through the DVFS technology, and to reduce power consumption as much as possible on the premise of meeting real-time performance. For instance, DVFS technology can be applied directly to lower system power consumption by utilizing the OSCAR API when writing multitasking programs. Alternatively, by dividing a task into multiple segments based on its control flow, the required execution time for each segment can be determined. This allows for the adjustment of the operating frequency and voltage via DVFS, aiming to minimize power consumption while ensuring real-time performance is maintained.

For another example, it is found that a task with high processor core utilization may often improve performance by increasing a number of processor cores, and a task with a small number of processor cores may improve performance by increasing processor frequency. Therefore, a processing strategy is proposed that a task with higher processor core utilization receives additional processor core(s) first, and a task with a small number of processor cores prioritizes improving its DVFS level to improve the performance-to-power ratio.

Through the analysis of the above-mentioned related art, it is found that in the low-power schemes of a symmetric multiprocessing system, the power consumption is reduced through processor resource allocation and hardware-supported low-power schemes such as the DVFS. In terms of hardware-supported low-power schemes, there is no research from the perspective of processor idleness.

For the method of reducing power consumption by leaving the processor in an idle state, the longer the idle duration of a single core is, the better the effect in power consumption reduction is.

Because the related symmetric multiprocessing task scheduling scheme does not start from the perspective of power consumption, it cannot integrate the idle states of multiple cores from the level of system task scheduling. The running states of cores vary randomly according to the changes of system tasks, the idle states of multiple cores also appear randomly, and the idle windows of multiple cores are random, which are not conducive to reducing power consumption.

In order to solve the above problem, the present disclosure provides a task scheduling method and apparatus based on a multi-core processor, an electronic device, a storage medium, a system and a computer program product, the idle time of multiple cores in a symmetric multiprocessing system may be integrated from the perspective of system task scheduling, in order to enable the idle processor cores to continuously keep an idle state as much as possible, so that the idle time of the processor cores may be integrated to the greatest extent by increasing a running density of the processor cores on the premise of not affecting the system running efficiency.

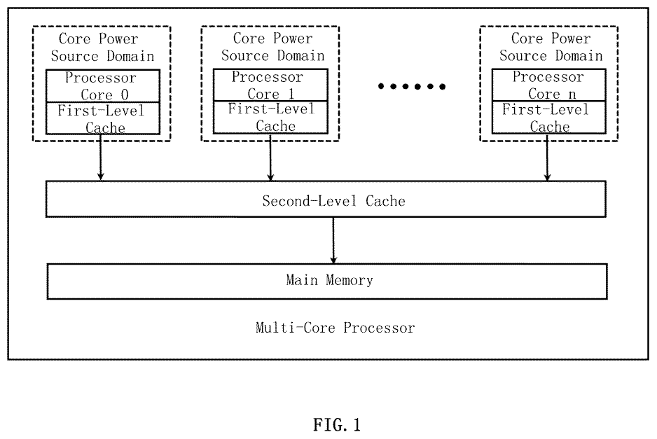

Hereinafter, the task scheduling method and apparatus based on a multi-core processor, the electronic device, the storage medium, the system, and the computer program product of the present disclosure will be specifically described with reference to FIG. 1 to FIG. 9.

FIG. 1 illustrates a schematic diagram of a structure of a multi-core processor in the related art.

Referring to FIG. 1, in a multi-core processor, for example, processor cores 0 to N, where N is an integer greater than 1, each processor core may contain a first-level Cache (Cache Memory), the cores may share a second-level Cache to reduce dependence on a main memory, and each processor core may be placed in an independent power domain. A power domain refers to a section of an integrated circuit (IC) or system-on-chip (SoC) where the power supply can be controlled independently. Different power domains allow for selective powering on, off, or scaling of voltage and frequency within specific regions of the chip to optimize power consumption. In a system with multiple power domains, each domain can be managed separately, enabling energy-saving techniques such as dynamic voltage and frequency scaling (DVFS) and power gating. These techniques are critical in modern processors and embedded systems to balance performance needs with energy efficiency. Each processor core in a multi-core processor may support multiple low-power modes, and the processor core and its cache may be powered off independently. For a single processor core, different power consumption modes may be selected for different idle times. If the idle duration is longer, a power consumption mode with lower power consumption may be selected. In this way, when an idle duration of a single processor core is equal to the accumulated idle duration of multiple processor cores, power saving of the single processor core may be greater than a sum of power saving of the multiple processor cores.

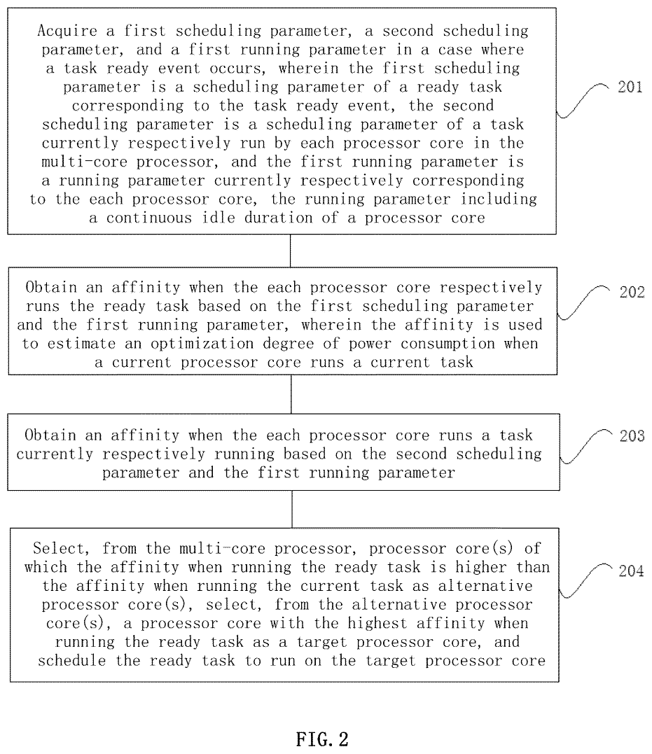

FIG. 2 illustrates a flowchart of a task scheduling method based on a multi-core processor in an exemplary embodiment of the present disclosure.

Referring to FIG. 2, in step 201, a first scheduling parameter, a second scheduling parameter, and a first running parameter may be acquired in a case where a task ready event occurs. The first scheduling parameter is a scheduling parameter of a ready task corresponding to the task ready event. The second scheduling parameter is a scheduling parameter of a task currently respectively run by each processor core in the multi-core processor. In an embodiment, the second scheduling parameter is a scheduling parameter of a task currently being run by at least one processor core (i.e., a scheduling parameter of a current task). The first running parameter is a running parameter currently respectively corresponding to each processor core. The running parameter may include a continuous idle duration of a processor core.

According to the exemplary embodiment of the present disclosure, an optimal scheduling of a destination processor core (i.e., target processor core) may be computed by acquiring scheduling parameters of various tasks and running parameters of various processor cores in a case where a task ready event occurs. The acquired first scheduling parameter may be a scheduling parameter of a ready task corresponding to the task ready event. The acquired second scheduling parameter may be a scheduling parameter of a task currently respectively run by each processor core in the multi-core processor. In an embodiment, the second scheduling parameter is a scheduling parameter of a task currently being run by at least one processor core. For example, when a multi-core processor has four processor cores, three processor cores runs a task and the remaining one processor core is in an idle state the acquired second scheduling parameter may be a scheduling parameter of the task currently run by three processor cores. If the three processor cores currently run different tasks, the acquired second scheduling parameter may include scheduling parameters of the three different tasks. In an embodiment, the acquired second scheduling parameter may include a scheduling parameter of no task currently running. The acquired first running parameter is a running parameter of each processor core. The running parameter may include a continuous idle duration of a processor core. By acquiring the running parameter including a continuous idle duration of a processor core, a target processor core may be selected by integrating an idle duration of a single processor core. For example, the three processor cores currently running a task has a value indicating no continuous idle time, and the remaining one processor core which is now in an idle state has a value indicating a duration time of the idle state. When a target processor core is selected for the ready task, the running parameter of each processor core including the continuous idle duration thereof may be considered.

In step 202, based on the first scheduling parameter and the first running parameter, an affinity when each processor core runs the ready task may be obtained. The affinity represents an optimization degree of power consumption when a current processor core runs a current task. For example, an affinity of each processor core may be determined by simulating execution of the ready task as a current task based on the first scheduling parameter and the first running parameter.

According to the exemplary embodiment of the present disclosure, a degree of optimization of power consumption of any processor core running any task may be estimated/represented by defining an affinity between a processor core and a task. A value of the affinity may be calculated through the acquired scheduling parameter of the task and running parameter of the processor core. The first scheduling parameter and the first running parameter may be used to calculate the affinity between each processor core and the ready task when each processor core simulates execution of the ready task.

According to the exemplary embodiment of the present disclosure, the continuous idle duration of the processor core is inversely correlated with the affinity.

According to the exemplary embodiment of the present disclosure, in order to integrate the idle duration of a single processor core, in a case where the affinity is used to estimate/represent a degree of optimization of power consumption of any processor core running any task, the parameter of the continuous idle duration of the processor core may be enabled to be inversely correlated with a value of the affinity. For example, the idle time of each processor core may be factored in when estimating the level of power consumption optimization for each processor core.

In step 203, based on the second scheduling parameter and the first running parameter, an affinity when each processor core runs a task currently respectively running is obtained. For example, an affinity of each processor core may be determined by simulating execution of the current task based on the second scheduling parameter and the first running parameter.

According to the exemplary embodiment of the present disclosure, the second scheduling parameter and the first running parameter may be used to calculate an affinity between each processor core and its currently running task when each processor core runs its currently running task, respectively. In a case where there is a processor core that is not currently running a task, an affinity between the processor core and the state of not currently running a task may still be calculated.

It may be understood that there is no order of execution between step 202 and step 203.

According to the exemplary embodiment of the present disclosure, the running parameter may further include, but is not limited to, the number of times the processor core switches tasks during a current running cycle. In a multi-core processor, the “running cycle” refers to how the processor manages tasks or instructions across its multiple cores. Each core operates in cycles, with each cycle consisting of a set of steps to process instructions such as instruction fetch, instruction decode, execution, and memory access. Each processor core in a multi-core processor can run independent cycles simultaneously, which means that This means different cores can be executing instructions at different stages of the pipeline. Task scheduling (often handled by the operating system) ensures that different processes or threads are distributed among the available cores. If a task is parallelizable (multi-threaded), multiple cores may work on different parts of the same task concurrently.

According to the exemplary embodiment of the present disclosure, caching may improve code execution efficiency, but if task switching is performed frequently on one processor core, a hit ratio of the caching will be greatly reduced and resource consumption of task switching will be increased, thereby increasing power consumption. Therefore, it is necessary to avoid frequent task switching on the premise of satisfying task execution efficiency, so as to be able to reduce power consumption caused by task switching. A scheduling strategy with better power optimization results may be obtained in task scheduling of a multi-core processor by considering the number of times that a processor core switches tasks during a current running cycle as the running parameter of the processor core. For example, a more power-efficient scheduling strategy may be achieved in multi-core processor task scheduling by factoring in the number of task switches a processor core undergoes during its current execution cycle as the running parameter.

According to the exemplary embodiment of the present disclosure, the number of times that the processor core switches tasks during the current running cycle is positively correlated with the affinity. It is to be understood that the present disclosure aims to reduce the overall number of switches for respective processor cores in the multi-core processor to avoid frequent task switching of the processor cores in general while satisfying the task execution efficiency so as to be able to reduce the power consumption due to task switching, but the number of task switches of a certain processor core may become high.

According to the exemplary embodiment of the present disclosure, in order to avoid the processor core frequently switching tasks, in a case where the affinity is used to estimate/represent a degree of optimization of power consumption of any processor core running any task, the parameter of the number of times that the processor core switches tasks during the current running cycle may be enabled to be positively correlated with the affinity in estimating the affinity.

According to the exemplary embodiment of the present disclosure, the scheduling parameter may include, but is not limited to, at least one of a priority of a task and a waiting duration of the task. For example, the waiting time of a task indicates how much time has elapsed since a task ready event for the task occurred.

According to the exemplary embodiment of the present disclosure, for the scheduling parameter of a task, one or more of a priority of the task and a waiting duration of the task may be considered so as to obtain an affinity between any processor core and any task. It may be understood that the scheduling parameter of the task is not limited to the two listed above.

According to the exemplary embodiment of the present disclosure, each of the priority of the task and the waiting duration of the task may be positively correlated with the affinity.

According to the exemplary embodiment of the present disclosure, since the affinity is used to estimate/represent a degree of optimization of power consumption of any processor core running any task, in order to satisfy task execution efficiency and avoid task delay scheduling, the two parameters of the priority of the task and the waiting duration of the task may be enabled to be positively correlated with a value of the affinity.

In step 204, processor core(s) of which the affinity when running the ready task (i.e., ready-task affinity) is higher than the affinity when running the current task (i.e., current-task affinity) may be selected from the multi-core processor as alternative processor core(s), a processor core with the highest affinity when running the ready task is selected from the alternative processor core(s) as a target processor core, and the ready task may be scheduled to run on the target processor core.

According to the exemplary embodiment of the present disclosure, for each processor core, affinities when the processor core runs a task currently running and a ready task may be compared. For example, for each processor core, a value of ready-task affinity and a value of current-task affinity may be compared. If there is one processor core of which the affinity when running the ready task is higher than the affinity when running the currently running task, and of which the affinity when running the ready task is the highest among all the processor cores, that is, in a case where there is a processor core with the highest affinity when running the ready task, the processor core may be taken as a target processor core, and the ready task may be scheduled to run on the target processor core. For example, if a processor core has a higher affinity for the ready task compared to the currently running task, and this affinity is the highest among all processor cores, then this processor core may be selected as the target processor core, and the ready task may be scheduled to run on the target processor core.

According to the exemplary embodiment of the present disclosure, a scheduling principle for low-power load balancing of a symmetric multiprocessing system may be proposed in conjunction with various embodiments according to characteristics of processors:
(1) keeping the idle processor cores in an idle state continuously as much as possible; and
(2) reducing unnecessary switching of tasks between different cores as much as possible.

In order to implement the above scheduling principle for low-power load balancing, only as an example, the following processor core and task state parameters may be considered at the same time:

| | | Variable |
|---|---|---|
| No. | Parameter Description | Definition |
| 1 | continuous idle duration of the processor core | t_{I} |
| 2 | number of times that the processor core switches tasks | n_{T} |
| | during the current running cycle | |
| 3 | priority of the task | p |
| 4 | waiting duration of the task | t_{W} |

The affinity Cᵢⱼ of the processor core i to the task j may be defined as follows:

$${C}_{ij} = {af}_{1} ( {t}_{Ii} ) + {bf}_{2} ( {n}_{Ti} ) + {cf}_{3} ( {p}_{j} ) + {df}_{4} ( {t}_{Wj} ) \qquad ( Formula - 1 )$$

The definition of a parameter mapping relationship defined in Formula-1 may be as shown in the following table:

| | Mapping | |
|---|---|---|
| No. | Relationship | Definition |
| 1 | f₁(t_{Ii}) | inversely proportional to the continuous idle |
| | | duration of a processor core i |
| 2 | f₂(n_{Ti}) | positively proportional to the number of times that a |
| | | processor core i switches tasks during the current |
| | | running cycle |
| 3 | f₃(pⱼ) | positively proportional to the priority of a task j |
| 4 | f₄(t_{Wj}) | positively proportional to the waiting duration of a |
| | | task j |

A higher affinity value Cᵢⱼ calculated using Formula-1 suggests that scheduling a task j on a processor core i better aligns with the low-power load balancing principle defined in the present disclosure.

When the task k is ready, the current running parameter of each processor core i and the scheduling parameter of the task jᵢ currently running on the each processor core may be obtained; an affinity Cᵢⱼ; between the task jᵢ on each processor core and the corresponding processor core i may be calculated; an affinity Cᵢₖ between each processor core i and the ready task k may be calculated; for each processor core i, Cᵢₖ and Cᵢⱼ; may be compared, if Cᵢₖ is greater than Cᵢⱼ_{ᵢ}, Cᵢₖ may be added to an alternative set S.

If the set S is not empty, the processor core I corresponding to a maximum value Cₗₖ in the set S may be taken as a scheduling core (a target processor core) of the ready task k, that is, Cₗₖ=max{Cᵢₖ}, Cᵢₖ∈S. Then the ready task k may be scheduled to the target processor corel.

According to the exemplary embodiment of the present disclosure, the above scheduling method may further include the following steps: in a case where there is no processor core, in the multi-core processor, of which the affinity when running the ready task is higher than the affinity when running the current task, the ready task may be added to a preset global ready task list; in a case where a time slice exhaustion event occurs, a second running parameter, a third scheduling parameter and a fourth scheduling parameter may be acquired. The second running parameter may be a current running parameter of a processor core to be allocated that actively requests task scheduling. For example, when a time slice of a task processed by a certain processor core is exhausted, the processor core becomes a processor core to be allocated and needs to switch to a new task, at which time the processor core will take the initiative to request task scheduling, i.e., the processor core will send a request to the operating system to request task scheduling. For example, during a time when there is no selected target processor core, in response to a time slice exhaustion event occurs to a processor core, the processor core may request task scheduling using the global ready task list. The third scheduling parameter may be a scheduling parameter of a task running on the processor core to be allocated. The fourth scheduling parameter may be a scheduling parameter of an alternative task, and the alternative task may be a task with the highest priority in the global ready task list. Based on the second running parameter and the third scheduling parameter, an affinity when the processor core to be allocated runs a currently running task may be obtained. Based on the second running parameter and the fourth scheduling parameter, an affinity when the processor core to be allocated runs an alternative task may be obtained. In a case where the affinity when the processor core to be allocated runs the alternative task is higher than the affinity when the processor core to be allocated runs the currently running task, the alternative task may be scheduled to run on the processor core to be allocated.

According to the exemplary embodiment of the present disclosure, in a case where there is no processor core, in the multi-core processor, of which the affinity when running the ready task is higher than the affinity when running the current task, in other words, in a case where there is no target processor core with the highest affinity when running the ready task, in other words, if the above set S is empty, the ready task k may be added to the global ready task list.

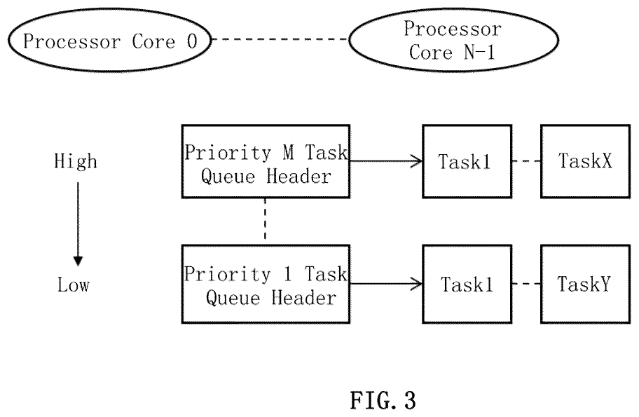

FIG. 3 illustrates a schematic diagram of a global ready task list in an exemplary embodiment of the present disclosure.

Referring to FIG. 3, according to the exemplary embodiment of the present disclosure, after a processor system is initialized, a global ready task list may be established in advance, and a corresponding empty linked list header may be generated for respective priorities in the global ready task list and placed in a task queue.

According to the exemplary embodiment of the present disclosure, tasks with the same priority may be executed in turn by means of polling in an embedded system. When a task time slice is exhausted, a time slice exhaustion event occurs, and the processor core needs to switch to a new task. At this time, the processor core will actively request task scheduling. For example, In order to realize concurrent multi-task processing, scheduling algorithms such as Round-Robin may be used, where each task may be allocated a time slice, which is a fixed period of time during which the processor core may specialize in processing the task; when a task is running on the processor core and its allocated time slice is exhausted, it means that the execution time of the task in the current round has ended. Since the time slice exhaustion, the processor core may no longer continue to process this current task (it cannot continue in the current round), but may start processing other tasks waiting to be executed. In order to be able to switch to a new task, the processor core may decide which task should be executed next through the scheduler of the operating system. Therefore, when the time slice is exhausted, the processor core may send a request to the operating system for task scheduling; upon receipt of the request, the scheduler of the operating system may select an appropriate new task and assign it to the processor core to be allocated for execution.

When a time slice of a current task of a certain processor core i is exhausted, the processor core i actively requests task scheduling, and task switching of the current task to a new task may be or may not be carried out according to a calculation result of affinity.

The specific steps may be as follows: the running parameter corresponding to a current state of the processor core i and the scheduling parameter of the task jᵢ currently running on the processor core i may be acquired in response to the time slice exhaustion event; an affinity Cᵢⱼ_{ᵢ} between the task jᵢ on the processor core i and the corresponding processor core i may be calculated; a first task in the highest priority list of the global ready task list may be taken as an alternative task k, and an affinity Cᵢₖ between the alternative task k and the processor core i may be calculated; if Cᵢₖ is greater than Cᵢⱼ_{ᵢ}, the alternative task k may be switched and scheduled to run on the processor core i. Otherwise, the task switching may not be carried out. For example, the task jᵢ currently running on the processor core i may be switched to the task j, and the task j may be scheduled to run on the processor core i.

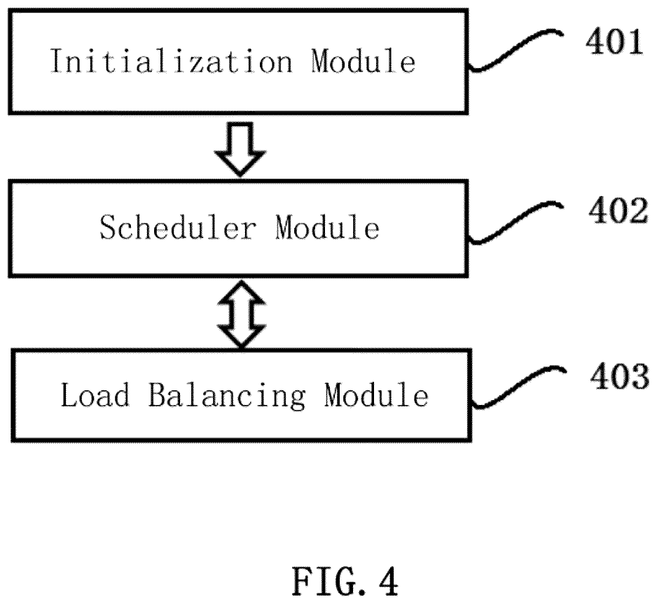

FIG. 4 illustrates a block diagram of modules for executing a task scheduling method based on a multi-core processor in an exemplary embodiment of the present disclosure.

Referring to FIG. 4, according to the exemplary embodiment of the present disclosure, the above task scheduling method based on a multi-core processor may be executed by coordinating a plurality of modules, for example, the method may be executed by coordinating an initialization module 401, a scheduler module 402, and a load balancing module 403.

It may also be understood that the respective modules may be software, hardware, firmware, or any combination thereof for performing corresponding functions.

The initialization module 401 may be responsible for initializing an environment required by the load balancing module 403. The scheduler module 402 may call relevant interfaces of the load balancing module 403 when receiving a task ready event or a time slice exhaustion event. The load balancing module 403 may calculate and compare affinity values of respective processor cores with respective tasks, and may return to the scheduler module 402 whether task switching is required and may return the best destination processor core for switching. If task switching is required, the scheduler module 402 may schedule a target task to the destination processor core. If task switching is not required, the scheduler module 402 may add the target task to a global ready task list.

According to the exemplary embodiment of the present disclosure, the above task scheduling method based on a multi-core processor may be divided into two processes of initialization and scheduling processing.

The initialization module 401 may perform establishment of a scheduling environment for low-power load balancing. After the processor system is initialized, a global ready task list is established in advance, and the continuous running time t, and the number of times nr that the processor core switches tasks within a latest fixed cycle T may be initialized for each processor core.

After the initialization is completed, the scheduler module 402 may wait for occurrence of a corresponding event such as a task ready event and a time slice exhaustion event, and may apply the task scheduling method based on a multi-core processor of the present disclosure to schedule according to the corresponding event.

When a task k is ready, the scheduler module 402 may call an interface of the load balancing module 403 to perform calculation for the optimal scheduling of the destination processor core, and the scheduler module 402 may add the ready task to the global ready task list or schedule the task to the destination processor core according to the calculation result.

According to the exemplary embodiment of the present disclosure, by comprehensively considering the states of the task and the processor core, for example, the running time of the processor core and the number of times of task switching, the priority of the currently running task and the waiting time of the processor core, etc., when a symmetric multiprocessing system performs task scheduling, the proposed low-power load balancing scheme of the symmetric multiprocessing system may obtain a selection of a processor core with optimal scheduling, which may integrate the idle time of the processor core to the greatest extent by increasing a running density of the processor core on the premise of not affecting the system running efficiency. The load balancing scheme of the exemplary embodiment of the present disclosure may integrate the idle state of the processor core to the greatest extent from the perspective of system running, and may effectively reduce the total power consumption of the symmetric multiprocessing system in combination with hardware low-power technology.

According to the exemplary embodiment of the present disclosure, the rationality and effectiveness of the task scheduling method based on a multi-core processor described in the present disclosure may be presented through the following specific scheduling scenarios.

Taking a four-core processor as an example, it is assumed that each processor core has four power-consumption running modes, which are labeled as M0, M1, M2 and M3 in order of power consumption from high to low. The four running modes M0, M1, M2, and M3 may have four levels of power consumption P₀, P₁, P₂ and P₃, respectively. The levels of the power consumption may have the following relationship: P₀>P₁>P₂>P₃.

The task scheduling method based on a multi-core processor described in the present disclosure can integrate the idle time of the processor core to the greatest extent to reduce power consumption. For example, the idle time of the processor core may be factored in to reduce power consumption in the task scheduling method. According to the low-power scheme of the current mainstream processor, the processor may enter different power consumption modes under different idle duration. When one unit time is defined as T, it may be defined that the corresponding running mode of the processor core is adjusted to M1, M2, M3 when the processor core is idle 0, 1*T, and 2*T, and when the processor core is not idle (RUN), the running mode is M0, as shown in the table below.

| | | Power |
|---|---|---|
| Idle Duration | Mode | Consumption |
| RUN | M0 | P0 |
| 0 | M1 | P1 |
| 1*T | M2 | P2 |
| 2*T | M3 | P3 |

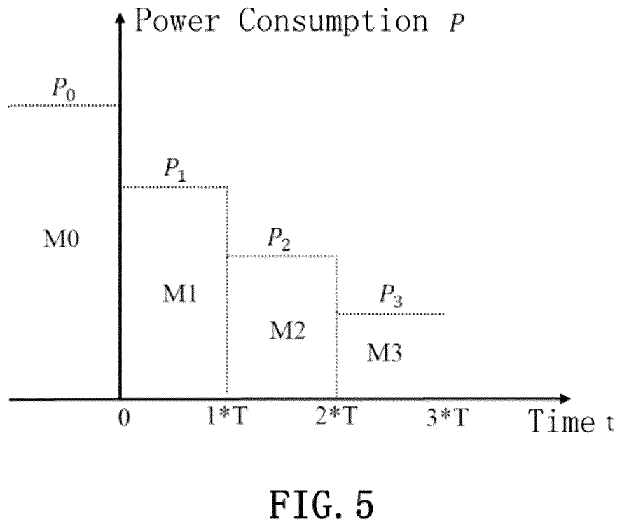

FIG. 5 illustrates a diagram of relationship between idle time of a processor core and a change in mode in an exemplary embodiment of the present disclosure.

Then, for a processor core, the change of its processor mode as its idle time increases may be referred to FIG. 5. That is, when the processor core is not idle, the running mode is M0, and the corresponding power consumption is P₀; when the processor core starts to be idle and is idle within 1*T, the running mode is M1, and the corresponding power consumption is P₁; when the processor core is idle after 1*T and within 2*T, the running mode is M1, and the corresponding power consumption is P₂; when the processor core is idle after 2*T and within 3*T, the running mode is M1, and the corresponding power consumption is P₃.

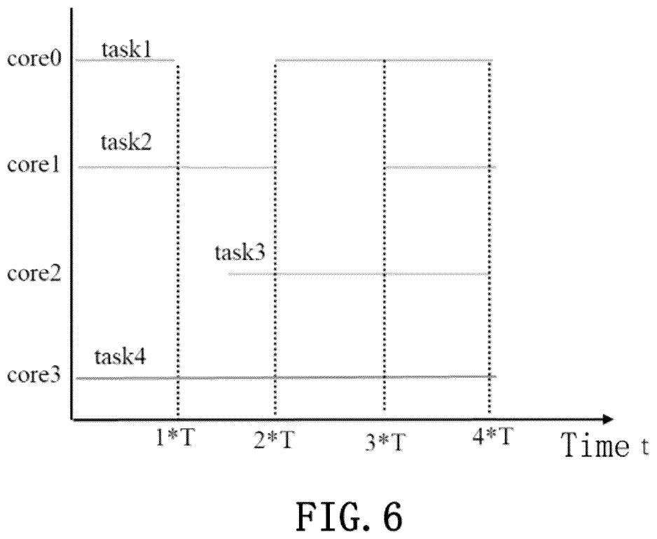

FIG. 6 illustrates a schematic diagram of running of a multi-core processor corresponding to a task scheduling scheme in the related art.

Referring to FIG. 6, it may be assumed that the symmetric multiprocessing system includes four processor cores, core0, core1, core2 and core3, and in a scheduling scheme based on normal task priority preemption in the related art, the respective processor cores run tasks, task1, task2, task3 and task4 respectively in four time units, as shown in FIG. 6. The total power consumption P_{z} of the task scheduling scheme is calculated according to FIG. 6, which may be P_{z}=4×4×P₀−(1+1+1.5)×P₀+3×P₁+0.5×P₂, that is, P₂=12.5×P₀+3×P₁+0.5×P₂.

Next, the task scheduling scheme shown in FIG. 6 may be optimized for power consumption by adopting the low-power load balancing method of a symmetric multiprocessing system proposed in the present disclosure (that is, a task scheduling method based on a multi-core processor in the present disclosure).

The functions ƒ₁~ƒ₄ in Formula-1 may be implemented as:

| Variable | Function Definition |
|---|---|
| 0t_{I} | f₁(t_{I}) = (100 − t_{I}) 0 ≤ t_{I} ≤ 100 = |
| | 0 t_{I} > 100 = |
| | 0 t_{I} < 0 |
| n_{T} | f₂(n_{T}) = n_{T} n_{T} ≤ 100 = |
| | 0 n_{T} > 100 |
| p | f₃(p) = p p ≤ 32 = |
| | 32 p > 32 |
| t_{w} | f₄(t_{w}) = t_{w} t_{w} ≤ 100 = |
| | 100 t_{w} > 100 |

Also, a=100, b=1, c=100, d=1 may be taken from Formula-1, to obtain the following Formula-2:

$${C}_{ij} = 100 {f}_{1} ( {t}_{Ii} ) + {f}_{2} ( {n}_{Tj} ) + 100 {f}_{3} ( {p}_{j} ) + {f}_{4} ( {t}_{Wj} ) \qquad ( Formula - 2 )$$

In FIG. 6, when t=1.5*T, the task3 is ready. According to the above Formula-2 and the implementation of ƒ₁~ƒ₄, parameter values required for the affinity between the respective processor cores and the respective tasks may be calculated. When a processor core is processing a task, its continuous idle duration is a continuous duration for processing the task and may take a negative value, and its task priority may take 16. The final calculation results may be as shown in the following table:

| | Calculation Parameter | | | | Calculation |
|---|---|---|---|---|---|
| | t_{I} | n_{T} | p | t_{w} | Result |
| C₀ⱼ_{₀} | 0.5 | 1 | 0 | 0 | 9951 |
| C₁ⱼ_{₁} | −1.5 | 1 | 16 | 0 | 1601 |
| C₂ⱼ_{₂} | 1.5 | 0 | 0 | 0 | 9850 |
| C₃ⱼ_{₃} | −1.5 | 1 | 16 | 0 | 1601 |
| C₀₃ | 0.5 | 1 | 16 | 0 | 11551 |
| C₁₃ | −1.5 | 1 | 16 | 0 | 1601 |
| C₂₃ | 1.5 | 0 | 16 | 0 | 11450 |
| C₃₃ | −1.5 | 1 | 16 | 0 | 1601 |

According to the task scheduling method based on a multi-core processor of the present disclosure, it may be obtained that an alternative set in the above case is S={C₀₃, C₂₃}, and the maximum value in the alternative set is max{C₀₃, C₂₃}=C₀₃, therefore, the task 3 may be scheduled to the processor core core0.

In FIG. 6, when t=2*T, task1 is ready again. According to Formula-2 and the implementation manner of ƒ₁~ƒ₄, after the task 3 is scheduled to the processor core core0, parameter values required for the affinity between the respective processor cores and the respective tasks may be calculated, and the final calculation results may be as shown in the following table:

| | Calculation Parameter | | | | Calculation |
|---|---|---|---|---|---|
| | t_{I} | n_{T} | p | t_{w} | Result |
| C₀ⱼ_{₀} | −0.5 | 2 | 16 | 0 | 1602 |
| C₁ⱼ_{₁} | 0 | 1 | 0 | 0 | 10001 |
| C₂ⱼ_{₂} | 2 | 0 | 0 | 0 | 9800 |
| C₃ⱼ_{₃} | −2 | 1 | 16 | 0 | 1601 |
| C₀₁ | −0.5 | 2 | 16 | 0 | 1602 |
| C₁₁ | 0 | 1 | 16 | 0 | 11601 |
| C₂₁ | 2 | 0 | 16 | 0 | 11400 |
| C₃₁ | −2 | 1 | 16 | 0 | 1601 |

According to the task scheduling method based on a multi-core processor of the present disclosure, it may be obtained that an alternative set in the above case is S={C₁₁, C₂₁}, and the maximum value in the alternative set is max{C₁₁, C₂₁}=C₁₁, therefore, the task1 may be scheduled to the processor core core1.

In FIG. 6, when t=3*T, the task 2 is ready again. According to Formula-2 and the implementation manner of ƒ₁~ƒ₄, after the task 1 is scheduled to the processor core core 1, parameter values required for the affinity between the respective processor cores and the respective tasks may be calculated, and the final calculation results may be as shown in the following table:

| | Calculation Parameter | | | | Calculation |
|---|---|---|---|---|---|
| | t_{I} | n_{T} | p | t_{w} | Result |
| C₀ⱼ_{₀} | −1.5 | 2 | 16 | 0 | 1602 |
| C₁ⱼ_{₁} | −1 | 2 | 16 | 0 | 1602 |
| C₂ⱼ_{₂} | 3 | 0 | 0 | 0 | 9300 |
| C₃ⱼ_{₃} | −3 | 1 | 16 | 0 | 1601 |
| C₀₂ | −1.5 | 2 | 16 | 0 | 1602 |
| C₁₂ | −1 | 2 | 16 | 0 | 1602 |
| C₂₂ | 3 | 0 | 16 | 0 | 10800 |
| C₃₂ | −3 | 1 | 16 | 0 | 1601 |

According to the task scheduling method based on a multi-core processor of the present disclosure, it may be obtained that an alternative set in the above case is S={C₂₂}, therefore, the task 2 may be scheduled to the processor core core 2.

In conclusion, the scheduling scheme after using a task scheduling method based on a multi-core processor described in the present disclosure may be shown in the following table:

| | | Destination |
|---|---|---|
| Time | Ready Task | Processor Core |
| 1.5*T | task3 | core0 |
| 2*T | task1 | core1 |
| 3*T | task2 | core2 |

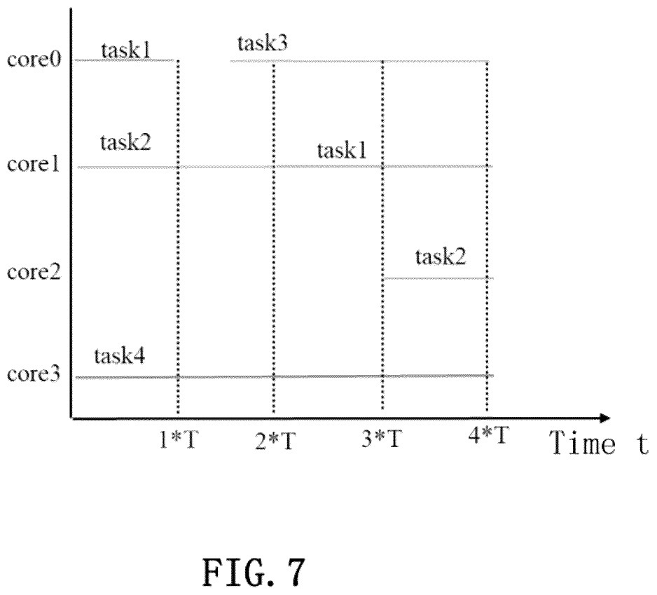

In combination with the above table, after using a task scheduling method based on a multi-core processor described in the present disclosure, the scheduling scheme shown in FIG. 6 may be optimized as the scheduling scheme shown in FIG. 7.

FIG. 7 illustrates a schematic diagram of running of a multi-core processor corresponding to a task scheduling scheme in an exemplary embodiment of the present disclosure. The task 3, which originally starts running on the core 2 at 1.5*T, is scheduled to run on the core 0, the task1, which originally starts running on the core1 at 2*T, is scheduled to run on the core 1, and the task 2, which originally starts running on the core1 at 3*T, is scheduled to run on the core 2.

The total power consumption Pₙ using a task scheduling scheme in the exemplary embodiment of the present disclosure may be calculated according to FIG. 7. The total power consumption Pₙ is: Pₙ=4×4×P₀−(3+0.5)×P₀+1.5×P₁+P₂+P₃, that is, Pₙ=12.5×P₀+1.5×P₁+P₂+P₃.

Since P0>P1>P2>P3, Pₙ-P_{z}=0.5×P₂+P₃-1.5×P₁<0, that is, Pₙ<P₂, so that using a task scheduling scheme in the exemplary embodiment of the present disclosure may reduce power consumption of a symmetric multiprocessing system.

According to the exemplary embodiment of the present disclosure, the present disclosure may perform power consumption optimization on a symmetric multiprocessing system from the perspective of task scheduling. By considering hardware characteristics that affect processor power consumption, a principle for low-power task scheduling for a symmetric multiprocessing system is proposed. According to the principle, a method of calculating an affinity between a task and a processor core is proposed. An optimal scheduling scheme may be determined according to the affinity while scheduling. Also, by performing experimental verification through actual task scheduling scenarios, and comparing with a scheduling scheme of normal task priority preemption, it may be seen that the low-power load balancing scheme method of a symmetric multiprocessing system proposed by the present disclosure may effectively integrate the idle time of multiple cores in the symmetric multiprocessing system, and provide conditions for supported hardware low-power scheme from the perspective of task scheduling, thereby reducing power consumption of the symmetric multiprocessing system.

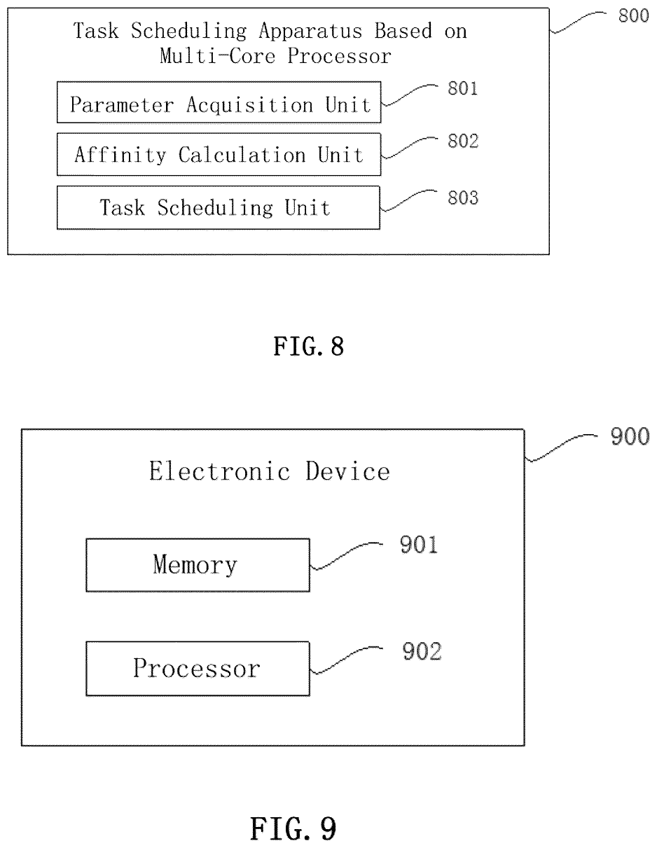

FIG. 8 illustrates a block diagram of a task scheduling apparatus based on a multi-core processor in an exemplary embodiment of the present disclosure.

Referring to FIG. 8, the exemplary embodiment of the present disclosure provides a task scheduling apparatus 800 based on a multi-core processor, which may include but is not limited to a parameter acquisition unit 801, an affinity calculation unit 802 and a task scheduling unit 803.

The parameter acquisition unit 801 may acquire a first scheduling parameter, a second scheduling parameter, and a first running parameter in a case where a task ready event occurs. The first scheduling parameter may be a scheduling parameter of a ready task corresponding to the task ready event, the second scheduling parameter may be a scheduling parameter of a task currently run by each processor core in the multi-core processor, the first running parameter may be a running parameter of each processor core, and the running parameter may include but is not limited to a continuous idle duration of a processor core.

The affinity calculation unit 802 may obtain, based on the first scheduling parameter and the first running parameter, an affinity when each processor core runs the ready task. The affinity represents an optimization degree of power consumption when a current processor core runs a current task. Based on the second scheduling parameter and the first running parameter, an affinity when each processor core runs a task currently running may be obtained.

The task scheduling unit 803 selects, from the multi-core processor, processor core(s) of which the affinity when running the ready task is higher than the affinity when running the current task as alternative processor core(s), selects, from the alternative processor core(s), a processor core with the highest affinity when running the ready task as a target processor core, and may schedule the ready task to run on the target processor core.

According to the exemplary embodiment of the present disclosure, in the above task scheduling apparatus 800 based on a multi-core processor, the continuous idle duration of the processor core is inversely correlated with the affinity.

According to the exemplary embodiment of the present disclosure, in the above task scheduling apparatus 800 based on a multi-core processor, the running parameter may further include but is not limited to the number of times the processor core switches tasks during the current running cycle.

According to the exemplary embodiment of the present disclosure, in the above task scheduling apparatus 800 based on a multi-core processor, the number of times the processor core switches tasks during the current running cycle is positively correlated with the affinity.

According to the exemplary embodiment of the present disclosure, in the above task scheduling apparatus 800 based on a multi-core processor, the scheduling parameter may include but is not limited to at least one of a priority of a task and a waiting duration of the task.

According to the exemplary embodiment of the present disclosure, in the above task scheduling apparatus 800 based on a multi-core processor, each of the priority of the task and the waiting duration of the task may be positively correlated with the affinity.

According to the exemplary embodiment of the present disclosure, the above task scheduling apparatus 800 based on a multi-core processor may further include, but is not limited to, an alternative task preparation unit (not shown in the drawing) adding the ready task to a preset global ready task list, in a case where there is no processor core, in the multi-core processor, of which the affinity when running the ready task is higher than the affinity when running the current task. The parameter acquisition unit 801 may further acquire, in a case where a time slice exhaustion event occurs, a second running parameter, a third scheduling parameter and a fourth scheduling parameter. The second running parameter may be a current running parameter of a processor core to be allocated that actively requests task scheduling, the third scheduling parameter may be a scheduling parameter of a task running on the processor core to be allocated, the fourth scheduling parameter may be a scheduling parameter of an alternative task, and the alternative task may be a task with the highest priority in the global ready task list. The affinity calculation unit 802 may further obtain, based on the second running parameter and the third scheduling parameter, an affinity when the processor core to be allocated runs a currently running task, and obtain, based on the second running parameter and the fourth scheduling parameter, an affinity when the processor core to be allocated runs an alternative task. The task scheduling unit 803 may further schedule, in a case where the affinity when the processor core to be allocated runs the alternative task is higher than the affinity when the processor core to be allocated runs the currently running task, the alternative task to run on the processor core to be allocated.

It may be understood that in the above exemplary embodiment of the task scheduling apparatus 800 based on a multi-core processor, the specific implementation process is substantially the same as in the above exemplary embodiment of the task scheduling method based on a multi-core processor, and will not be repeated here in detail. The task scheduling apparatus 800 based on a multi-core processor may be configured as software, hardware, firmware, or any combination thereof for performing specific functions. For example, these apparatuses may correspond to dedicated integrated circuits, software codes, or modules combining software and hardware. In addition, one or more functions implemented by these apparatuses may also be uniformly executed by components in a physical entity device (for example, a processor, a client, or a server, etc.).

FIG. 9 illustrates a block diagram of an electronic device in an exemplary embodiment of the present disclosure.

Referring to FIG. 9, an electronic device 900 includes at least one memory 901 and at least one processor 902. The at least one memory 901 stores a set of computer executable instructions. When executed by the at least one processor 902, the set of computer executable instructions executes the above task scheduling method based on a multi-core processor according to the exemplary embodiment of the present disclosure.

As an example, the electronic device 900 may be a PC computer, a tablet device, a personal digital assistant, a smart phone, or other devices capable of executing the above set of instructions. Here, the electronic device 900 does not have to be a single electronic device, but may also be any device or a collection of circuits that may execute the above instructions (or set of instructions) separately or jointly. The electronic device 900 may also be a part of an integrated control system or a system manager, or may be configured as a portable electronic device interconnecting with a local or remote (e.g., via wireless transmission) interface.

In the electronic device 900, the processor 902 may include a central processing unit (CPU), a graphics processing unit (GPU), a programmable logic device, a dedicated processor system, a microcontroller, or a microprocessor. As an example, the processor may also include an analog processor, a digital processor, a microprocessor, a multi-core processor, a processor array, a network processor, etc.

The processor 902 may execute instructions or codes stored in the memory 901, wherein the memory 901 may also store data. Instructions and data may also be transmitted and received via a network through a network interface device, wherein the network interface device may adopt any known transmission protocol.

The memory 901 may be integrated with the processor 902, for example, an RAM or flash memory is arranged in an integrated circuit microprocessor, etc. In addition, the memory 901 may include an independent device, such as an external disk drive, a storage array, or any other storage device that may be used by a database system. The memory 901 and the processor 902 may be operatively coupled, or may communicate with each other, for example, through an I/O port, a network connection, etc., so that the processor 902 can read files stored in the memory.

In addition, the electronic device 900 may also include a video display (such as a liquid crystal display) and a user interaction interface (such as a keyboard, a mouse, a touch input device, etc.). All components of the electronic device 900 may be connected to each other via a bus and/or a network.

According to the exemplary embodiment of the present disclosure, there may further provide a computer readable storage medium storing instructions, wherein the instructions, when executed by at least one computing device, cause the at least one computing device to execute the above task scheduling method based on a multi-core processor.

Examples of the computer readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), Flash, Non-Volatile Memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state drive (SSD), card storage (such as, Multimedia Cards, Secure Digital (SD) Cards or Extreme Digital (XD) Cards), magnetic tapes, floppy disks, magneto-optical data storage devices, optical data storage devices, hard disks, solid state disks, and any other device. The any other device is configured to store a computer program and any relevant data, data files and data structures in a non-transitory manner and to provide the computer program and any relevant data, data files and data structures to the processor or computer, so that the processor or computer may execute the computer program. The computer program in the above computer readable storage medium may run in an environment deployed in computer devices such as a client, a host, an agent device and a server. In addition, in one example, the computer program and any relevant data, data files and data structures are distributed over networked computer systems, so that the computer program and any relevant data, data files and data structures are stored, accessed and executed in a distributed manner by one or more processors or computers. It should be noted that the instructions may also be used to execute additional steps in addition to the above steps, or execute more specific processing when executing the above steps. These additional steps and further processed content have been mentioned in the description of the related method, and thus will not be repeated here in order to avoid repetition.

Another embodiment of the present disclosure relates to a system including at least one computing device and at least one storage device storing instructions, wherein the instructions, when executed by the at least one computing device, cause the at least one computing device to execute the above task scheduling method based on a multi-core processor.

It should be noted that the system of the exemplary embodiment of the present disclosure may completely rely on the running of the computer programs or instructions to implement corresponding functions, that is, respective units correspond to respective steps in the functional architecture of the computer program, so that the entire system is called through a special software package (for example, lib library) to implement the corresponding functions.

On the other hand, when the above system is implemented by software, firmware, middleware or microcode, a program code or code segment used to perform a corresponding operation may be stored in a computer readable medium such as a storage medium, so that at least one processor or at least one computing device may read and execute the corresponding program code or code segment to perform the corresponding operation.

According to the exemplary embodiment of the present disclosure, the storage device may be integrated with the computing device, for example, RAM or flash memory are arranged within an integrated circuit microprocessor, etc. In addition, the storage device may include an independent device, such as an external disk drive, a storage array, or any other storage device that may be used by a database system. The storage device and the computing device may be operationally coupled or may communicate with each other, for example, through an I/O port, a network connection, etc., so that the computing device can read instructions stored in the storage device.

Another embodiment of the present disclosure relates to a computer program product including computer programs/instructions, wherein the computer programs/instructions, when executed by a processor, implement any one task scheduling method based on a multi-core processor as described above.

According to the task scheduling method and apparatus based on a multi-core processor, the electronic device, the storage medium, the system and the computer program product provided in the present disclosure, when an idle duration of a single processor core is equal to the accumulated idle duration of multiple processor cores, power saving of the single processor core will be greater than a sum of power saving of the multiple processor cores, therefore, the idle time of multiple cores in a symmetric multiprocessing system may be integrated from the perspective of system task scheduling, in order to enable the idle processor cores to keep an idle state as much as possible, so that the idle time of the processor cores may be integrated to the greatest extent by increasing a running density of the processor cores on the premise of not affecting the system running efficiency.

In addition, unnecessary migration of tasks between different cores may be reduced as much as possible, and the power consumption caused by task switching may be reduced by avoiding frequent task switching on the premise of satisfying task execution efficiency.

In addition, from the perspective of task scheduling, conditions for supported hardware low-power schemes are provided to optimize the power consumption of a symmetric multiprocessing system. By comprehensively considering scheduling parameters of tasks and hardware characteristics that affect processor power consumption, low-power task scheduling for a symmetric multiprocessing system is proposed for load balancing, and an affinity representation between tasks and processor cores is proposed to determine the best scheduling scheme for power consumption optimization by comparing the affinity between the respective processor cores and tasks during task scheduling.

Various exemplary embodiments of the present disclosure are described above. It should be understood that the above descriptions are only exemplary, but not limited. The present disclosure is not limited to the disclosed various exemplary embodiments. With no deviation from the scope and spirit of the present disclosure, many modifications and variations are obvious to those skilled in the art. Therefore, the protection scope of the present disclosure should be subject to the scope of the claims.

What is claimed is:

1. A task scheduling method based on a multi-core processor including a plurality of processor cores, comprising:
acquiring a first scheduling parameter, a second scheduling parameter, and a first running parameter in a case where a task ready event occurs, wherein the first scheduling parameter is a scheduling parameter of a ready task corresponding to the task ready event, the second scheduling parameter is a scheduling parameter of a current task currently running in each processor core of the plurality of processor cores in the multi-core processor, and the first running parameter is a running parameter of each processor core of the plurality of processor cores, the running parameter comprising a continuous idle duration of each processor core of the plurality of processor cores;
obtaining, based on the first scheduling parameter and the first running parameter, a ready-task affinity of each processor core of the plurality of processor cores with the ready task, wherein the obtaining of the ready-task affinity of each processor includes running the ready task on each processor core, and wherein the ready-task affinity of each processor core with the ready task represents an optimization degree of power consumption when each processor core runs the ready task;
obtaining, based on the second scheduling parameter and the first running parameter, a current-task affinity of each processor core of the plurality of processor cores with the current task, wherein each processor core runs a corresponding current task or is in an idle state;
selecting, from the multi-core processor, at least one processor core as at least one alternative processor core, wherein the at least one processor core selected as the at least one alternative process core has a ready-task affinity higher than a current-task affinity;
selecting, from the at least one alternative processor core, a processor core with the highest ready-task affinity as a target processor core; and
scheduling the ready task to run on the target processor core.

2. The task scheduling method of claim 1,
wherein the continuous idle duration of each processor core is inversely correlated with the ready-task affinity.

3. The task scheduling method of claim 1,
wherein the running parameter further comprises a number of times each processor core switches tasks during a current running cycle.

4. The task scheduling method of claim 3,
wherein the number of times each processor core switches the tasks during the current running cycle is positively correlated with the ready-task affinity of each processor core.

5. The task scheduling method of claim 1,
wherein the scheduling parameter comprises at least one of a priority of a task and a waiting duration of the task.

6. The task scheduling method of claim 5,
wherein each of the priority of the ready task and the waiting duration of the ready task is positively correlated with the ready-task affinity.

7. The task scheduling method of claim 1, further comprising:
in a case where there is no processor core, in the multi-core processor, of which a ready-task affinity is higher than a current-task affinity, adding the ready task to a global ready task list;
in a case where a time slice exhaustion event occurs, acquiring a second running parameter, a third scheduling parameter and a fourth scheduling parameter, wherein the second running parameter is a current running parameter of a processor core to be allocated that requests task scheduling, the third scheduling parameter is a scheduling parameter of a task currently running on the processor core to be allocated, and the fourth scheduling parameter is a scheduling parameter of an alternative task, the alternative task being a task with the highest priority in the global ready task list;
obtaining, based on the second running parameter and the third scheduling parameter, a first affinity when the processor core to be allocated runs a currently running task;
obtaining, based on the second running parameter and the fourth scheduling parameter, a second affinity when the processor core to be allocated runs the alternative task; and
in a case where the second affinity is higher than the first affinity, scheduling the alternative task to run on the processor core to be allocated.

8. A task scheduling apparatus based on a multi-core processor including a plurality of processor cores, comprising:
a parameter acquisition unit configured to acquire a first scheduling parameter, a second scheduling parameter, and a first running parameter in a case where a task ready event occurs,
wherein the first scheduling parameter is a scheduling parameter of a ready task corresponding to the task ready event in the multi-core processor, the second scheduling parameter is a scheduling parameter of a current task currently running in each processor core of the plurality of processor cores in the multi-core processor, and the first running parameter is a running parameter of each processor core of the plurality of processor cores, the running parameter comprising a continuous idle duration of each processor core of the plurality of processor cores;
an affinity calculation unit configured to:
obtain, based on the first scheduling parameter and the first running parameter, a ready-task affinity of each processor core of the plurality of processor cores with the ready task, when each processor core of the plurality of processor cores runs the ready task, wherein the ready-task affinity of each processor core with the ready task represents an optimization degree of power consumption when each processor core of the plurality of processor cores runs the ready task, and
obtain, based on the second scheduling parameter and the first running parameter, a current-task affinity when each processor core runs a corresponding task or is in an idle state; and
a task scheduling unit configured to:
select, from the multi-core processor, at least one processor core as at least one alternative processor core, wherein the at least one processor core has a ready-task affinity higher than a current-task affinity,
select, from the at least one alternative processor core, a processor core with the highest affinity as a target processor core, and
schedule the ready task to run on the target processor core.

9. The task scheduling apparatus of claim 8,
wherein the continuous idle duration of each processor core is inversely correlated with the ready-task affinity.

10. The task scheduling apparatus of claim 8,
wherein the running parameter further comprises a number of times each processor core switches tasks during a current running cycle.

11. The task scheduling apparatus of claim 10,
wherein the number of times each processor core switches the tasks during the current running cycle is positively correlated with the ready-task affinity.

12. The task scheduling apparatus of claim 8,
wherein the scheduling parameter comprises at least one of a priority of a task and a waiting duration of the task.

13. The task scheduling apparatus of claim 12,
wherein each of the priority of the task and the waiting duration of the task is respectively positively correlated with the ready-task affinity.

14. The task scheduling apparatus of claim 8, further comprising:
an alternative task preparation unit configured to:
in a case where there is no processor core, in the multi-core processor, of which a ready-task affinity is higher than a current-task affinity, add the ready task to a global ready task list, and
in a case where a time slice exhaustion event occurs, acquire a second running parameter, a third scheduling parameter and a fourth scheduling parameter, wherein the second running parameter is a current running parameter of a processor core to be allocated that requests task scheduling, the third scheduling parameter is a scheduling parameter of a task currently running on the processor core to be allocated, and the fourth scheduling parameter is a scheduling parameter of an alternative task, the alternative task being a task with the highest priority in the global ready task list;
wherein the affinity calculation unit further configured to:
obtain, based on the second running parameter and the third scheduling parameter, a first affinity when the processor core to be allocated runs a currently running task; and
obtain, based on the second running parameter and the fourth scheduling parameter, a second affinity when the processor core to be allocated runs the alternative task; and
wherein the task scheduling unit further configured to: in a case where the second affinity is higher than the first affinity when the processor core to be allocated runs the currently running task, schedule the alternative task to run on the processor core to be allocated.

15. An electronic device, comprising:
at least one multi-core processor including a plurality of processor cores and executing
at least one memory storing computer executable instructions,
wherein the computer executable instructions cause the at least one multi-core processor to execute a task scheduling method,
wherein the at least one multi-core processor includes:
a parameter acquisition unit configured to acquire a first scheduling parameter, a second scheduling parameter, and a first running parameter in a case where a task ready event occurs,
wherein the first scheduling parameter is a scheduling parameter of a ready task corresponding to the task ready event in the multi-core processor, the second scheduling parameter is a scheduling parameter of a current task currently running in each processor core of the plurality of processor cores in the multi-core processor, and the first running parameter is a running parameter of each processor core of the plurality of processor cores, the running parameter comprising a continuous idle duration of each processor core of the plurality of processor cores;
an affinity calculation unit configured to:
obtain, based on the first scheduling parameter and the first running parameter, a ready-task affinity of each processor core of the plurality of processor cores with the ready task, when each processor core of the plurality of processor cores runs the ready task, wherein the ready-task affinity of each processor core with the ready task represents an optimization degree of power consumption when each processor core of the plurality of processor cores runs the ready task, and
obtain, based on the second scheduling parameter and the first running parameter, a current-task affinity when each processor core runs a corresponding task or is in an idle state; and
a task scheduling unit configured to:
select, from the multi-core processor, at least one processor core as at least one alternative processor core, wherein the at least one processor core has a ready-task affinity higher than a current-task affinity,
select, from the at least one alternative processor core, a processor core with the highest affinity as a target processor core, and
schedule the ready task to run on the target processor core.
